(19) United States
(12) Patent Application Publication
(10) Pub. No.: US 2014/0177202 A1
(43) Pub. Date: Jun. 26, 2014

(54) ILLUMINATION DEVICE HAVING LASER SOURCE

(71) Applicant: Hon Hai Precision Industry Co., Ltd., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 13/972,871

(22) Filed: Aug. 21, 2013

(30) Foreign Application Priority Data
Dec. 26, 2012 (TW) 101150275

(51) Int. Cl. F21V 13/08

(52) U.S. Cl. CPC F21V 13/08
USPC 362/84

(57) ABSTRACT

An illumination device includes a laser source, a splitter, a fluorescent member, and a reflector group. The laser source emits laser beams. The splitter divides the laser beams into three parts. The fluorescent member includes phosphor. The reflector group reflects the three parts of the laser beams to the fluorescent member from different directions to excite the phosphor in the fluorescent member.

### BACKGROUND

1. Technical Field

The disclosure relates to an illumination device, and particularly to an illumination device having a laser source.

2. Description of Related Art

LEDs have many beneficial characteristics, including low electrical power consumption, low heat generation, long lifetime, small volume, good impact resistance, fast response and excellent stability. These characteristics have enabled LEDs to be widely used as a light source in electrical appliances and electronic devices.

A conventional LED generally generates a smooth round light field with a radiation angle of 120 degrees (i.e. ±60 degrees). The light emitted from the LED is mainly concentrated at a center thereof. The light at a periphery of the LED is relatively poor and typically cannot be used to illuminate. Therefore the LED cannot be used in a lamp which requires a wide illumination range, for example, an explosion-proof lamp (which may be fitted to a miner's safety helmet) or a gas station canopy lamp.

What is needed, therefore, is an improved illumination device which overcomes the above described shortcomings.

### BRIEF DESCRIPTION OF THE DRAWINGS

FIG. 1 is a schematic view of an illumination device according to a first embodiment of the present disclosure.

FIG. 2 is a schematic view of an illumination device according to a second embodiment of the present disclosure.

### DETAILED DESCRIPTION

Embodiments of an illumination device in accordance with the present disclosure will now be described in detail below and with reference to the drawings.

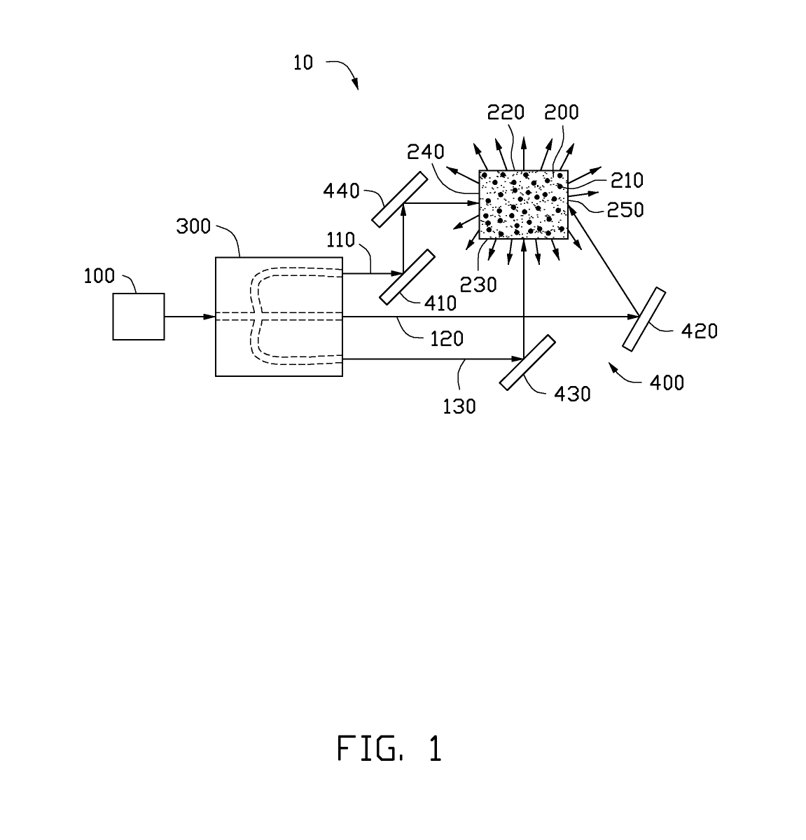

Referring to FIG. 1, an illumination device 10 in accordance with a first embodiment of the disclosure includes a laser source 100, a fluorescent member 200, a splitter 300, and a reflector group 400.

The laser source 100 emits laser beams having a narrow spectrum. In this embodiment, the laser source 100 is a laser light emitting diode and emits blue laser beams.

The fluorescent member 200 is located at a top of a right side of the laser source 100. In this embodiment, a cross section of the fluorescent member 200 is rectangular. The fluorescent member 200 is a mixture mixed with resin and phosphor 210. The fluorescent member 200 includes a top surface 220, a bottom surface 230 opposite to the top surface 220, and lateral surfaces connecting lateral edges of the top surface 220 and the bottom surface 230. The lateral surfaces include a left surface 240 and the right surface 250 opposite to the left surface 240. In this embodiment, the phosphor 210 is a yellow phosphor and material thereof is selected from sulfide phosphor, silicate phosphor, nitride phosphor, nitrogen oxides phosphor, or yttrium aluminum garnet (YAG) phosphor.

The splitter 300 is located between the laser source 100 and the fluorescent member 200 to divide the laser beams emitted from the laser source 100 to a plurality of parts. In this embodiment, the splitter 300 is an optical waveguide splitter and divides the laser beams emitted from the laser source 100 into a first part 110, a second part 120 and a third part 130. The first part 110, the second part 120 and the third part 130 have the same intensity.

The reflector group 400 is located at light paths of the first part 110, the second part 120 and the third part 130 to reflect the first part 110, the second part 120 and the third part 130 to the fluorescent member 200. In this embodiment, the reflector group 400 includes a first reflector 410 located at the light path of the first part 110, a second reflector 420 located at the light path of the second part 120, and a third reflector 430 located at the light path of the third part 430. The first reflector 410 is located at a bottom of a left side of the fluorescent member 200 to vertically reflect the first part 110 upwardly. The reflector group 400 further comprises a fourth reflector 440 located at a top of the first reflector 410. The fourth reflector 440 reflects the laser beams vertically reflected by the first reflector 410 to the left surface 240. In this embodiment, the first reflector 410 and the fourth reflector 440 are spaced and parallel to each other. The fourth reflector 440 reflects the laser beams to the left surface 240 in parallel.

The second reflector 420 is located at a bottom of a right side of the fluorescent member 200 to reflect the second part 120 to the right surface 250 of the fluorescent member 200. In this embodiment, the second reflector 420 slantwise reflects the second part 120 to the right surface 250. The third reflector 430 is located at a bottom of the bottom surface 230 to reflect the third part 130 to the bottom surface 230. In this embodiment, the third reflector 430 vertically reflects the third part 130 to the bottom surface 230.

It is understood, in other embodiment, the number of the reflectors and positions of the reflectors are adjustable according to requirements of the other embodiment as soon as the laser beams are reflected to the fluorescent member 200.

In operation, the laser source 100 is powered on and emits the laser beams oriented towards the splitter 300, the splitter 300 divides the laser beams to the first part 110, the second part 120 and the third part 130, and the first part 110, the second part 120, and the third part 130 are reflected by the reflector group 400 to the fluorescent member 200 to excite the phosphor 210 to obtain white light. The white light radiates from the top surface 220, the bottom surface 230 and the lateral surfaces of the fluorescent member 200 to illuminate. Thus overall, the illumination device 10 has a radiation angle approaching 360 degrees.

Because the intensity of the first part 110, the second part 120 and the third part 130 are equal, and the first part 110, the second part 120 and the third part 130 excite the phosphor 210 from different sides of the fluorescent member 200, the phosphor 210 located at different sides of the fluorescent member 200 is evenly excited. Thus, the white light evenly radiates from sides of the fluorescent member 200.

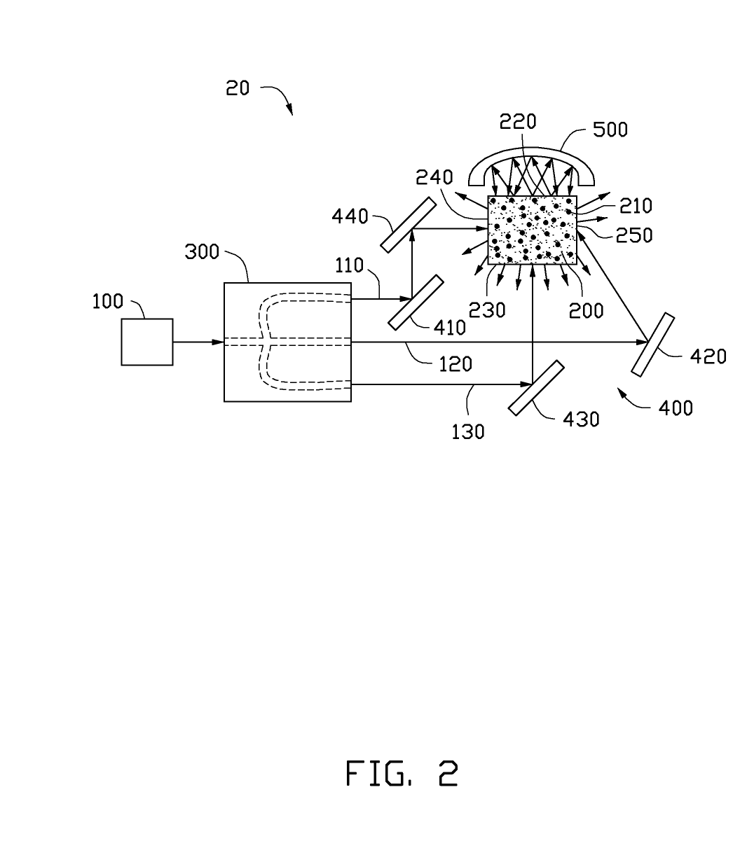

Referring to FIG. 2, an illumination device 20 of a second embodiment is shown. The illumination device 20 is similar to the illumination device 10, differences therebetween are that a covering 500 is located at a top of the fluorescent member 200 and covers the top surface 220. The covering 500 is arc-shaped. The covering 500 reflects the laser beam radiated out from the top surface 220 into the fluorescent member 200. The laser beam reflected by the covering 500 radiates out from the bottom surface 230 and the lateral surfaces. Because a part of the laser beams are reflected into the fluorescent member 200, more phosphor 210 of the fluorescent member 200 is excited relative to the first embodiment.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An illumination device comprising:
a laser source emitting laser beams;
a splitter dividing the laser beams into a plurality of parts;
a fluorescent member comprising phosphor; and
a reflector group reflecting the parts of the laser beams to the fluorescent member from different directions to excite the phosphor in the fluorescent member.

2. The illumination device of claim 1, wherein the laser source is a laser light emitting diode.

3. The illumination device of claim 1, wherein the fluorescent member is a mixture mixed with resin and phosphor, and material of the phosphor is selected from sulfide phosphor, silicate phosphor, nitride phosphor, nitrogen oxides phosphor, or yttrium aluminum garnet phosphor.

4. The illumination device of claim 1, wherein the laser source emits blue light and the phosphor is yellow phosphor.

5. The illumination device of claim 1, wherein the fluorescent member comprises a top surface, a bottom surface opposite to the top surface, and lateral surfaces connecting lateral edges of the top surface and the bottom surface.

6. The illumination device of claim 5, wherein the laser beams are divided to a first part, a second part and a third part, the reflector group is located at light paths of the first part, the second part and the third part to reflect the first part to the bottom surface of the fluorescent member, the second part and the third part to opposite lateral surface of the fluorescent member.

7. The illumination device of claim 6, wherein the reflector group comprises a first reflector, a second reflector, and a third reflector are respectively located at the light paths of the first part, the second part and the third part.

8. The illumination device of claim 7, wherein the first reflector is located at a bottom of a left side of the fluorescent member to vertically reflect the first part upwardly, the second reflector is located at a bottom of a right side of the fluorescent member to slantwise reflects the second part to one of the lateral surface, and the third reflector is located at a bottom of the bottom surface to vertically reflect the third part to the bottom surface.

9. The illumination device of claim 8 further comprising a fourth reflector located at a top of the first reflector to reflect the laser beams reflected by the first reflector to the other lateral surface of the fluorescent member.

10. The illumination device of claim 9, wherein the first reflector and the fourth reflector are spaced from and parallel to each other.

11. The illumination device of claim 5, wherein a cover located at a top of the fluorescent member and covers the top surface of the fluorescent member to reflect light radiating out from the top surface.

12. The illumination device of claim 11, wherein the cover is a convex sheet.

13. The illumination device of claim 1, wherein the splitter is an optical waveguide splitter.

14. The illumination device of claim 1, wherein each part of the divided laser beams has the same intensity.
